(19) United States
(12) Patent Application Publication
(10) Pub. No.: US 2009/0146807 A1
(43) Pub. Date: Jun. 11, 2009

(54) MULTIFUNCTION CAMERA WITH AN ENVIRONMENT SENSING FUNCTION

(75) Inventor: CHEN-HSING CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/108,062

(22) Filed: Apr. 23, 2008

(30) Foreign Application Priority Data
Dec. 11, 2007 (CN) 200710202995.X

(51) Int. Cl. G08B 21/00; G08B 23/00

(52) U.S. Cl. 340/540; 340/500

(57) ABSTRACT

A multifunction camera includes an image capturing unit, a sensing unit, a storing unit, a control unit, and a warning unit. The image capturing unit is for capturing images. The sensing unit is for obtaining current environmental parameters of an immediate environment where the multifunction camera is used. The storing unit is for storing the images, the current environmental parameters, and predetermined safe environmental parameters. The control unit is for receiving the current environmental parameters, and comparing the current environmental parameters with the predetermined safe environmental parameters, and generating a warning signal if any of the current environmental parameters is outside a range of the corresponding predetermined safe environmental parameter. The warning unit is for activating a warning indicator in response to the warning signal.

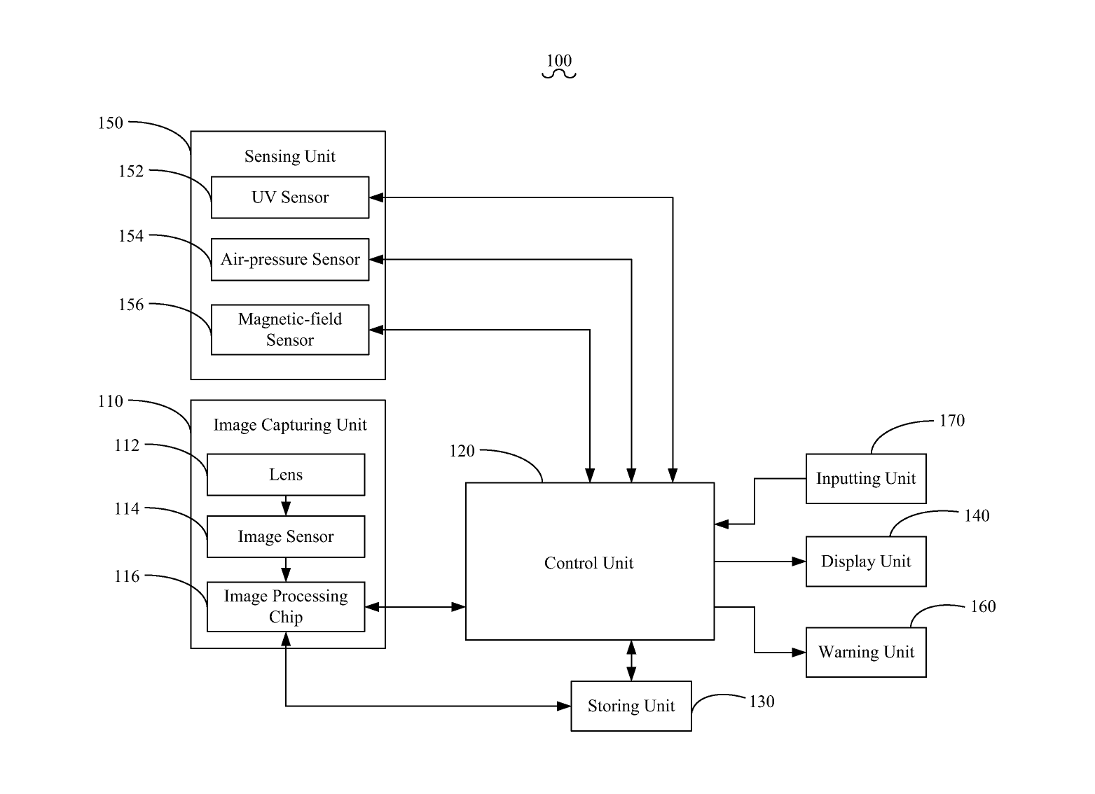

### BACKGROUND

1. Field of the Invention

The present invention relates to a multifunction camera, and more particularly, to a multifunction camera with an environment sensing function.

2. Description of Related Art

Cameras are widely used for capturing images. Camera users will often use their equipment outdoors, such as when hiking and exploring. Users may venture into dangerous environments without knowing.

What is needed, therefore, is to provide a multifunction camera which can provide information on the immediate environment.

### SUMMARY

The present invention relates to a multifunction camera. The multifunction camera includes an image capturing unit, a sensing unit, a storing unit, a control unit, and a warning unit. The image capturing unit is configured for capturing images. The sensing unit is configured for obtaining current environmental parameters of an immediate environment where the multifunction camera is used. The storing unit is configured for storing the images, the current environmental parameters, and predetermined safe environmental parameters. The control unit is configured for receiving the current environmental parameters, and comparing the current environmental parameters with the predetermined safe environmental parameters, and generating a warning signal if any of the current environmental parameters is outside a range of the corresponding predetermined safe environmental parameter. The warning unit is configured for activating a warning indicator in response to the warning signal.

Other advantages and novel features of the present invention will become more apparent from the following detailed description of present embodiments when taken in conjunction with the accompanying drawings.

### BRIEF DESCRIPTION OF THE DRAWINGS

The FIGURE is a function block diagram of a multifunction camera according to an exemplary embodiment.

### DETAILED DESCRIPTION OF THE EMBODIMENTS

Reference will now be made to the FIGURES to describe at least one present embodiment in detail.

Referring to the FIGURE, a multifunction camera 100, according to an exemplary embodiment, is shown. The multifunction camera 100 includes an image capturing unit 110, a control unit 120, a storing unit 130, a display unit 140, a sensing unit 150, a warning unit 160, and an input unit 170.

The image capturing unit 110 includes a lens 112, an image sensor 114, and an image processing chip 116. The lens 112 and the image sensor 114 are arranged in order along a light path of the image capturing unit 110. Light from the lens 112 is sensed by the image sensor 114 for conversion into electrical signals. The electrical signals are transmitted to the image processing chip 116 to be processed to form images. The images are stored in the storing unit 130, and can be shown on a display of the display unit 140.

The sensing unit 150 is configured for obtaining current environmental parameters of an immediate environment in which the multifunction camera 100 is used. The current environmental parameters are stored in the storing unit 130. In the present embodiment, the sensing unit 150 includes an ultraviolet (UV) sensor 152 for detecting a current UV intensity of the immediate environment, an air pressure sensor 154 for detecting a current air pressure of the immediate environment, and a magnetic field sensor 156 for detecting a current magnetic field intensity of the immediate environment. The current environmental parameters can be shown in a display of the display unit 140.

Safe environmental parameters are predefined and stored in the storing unit 130. In the present embodiment, the safe environmental parameters include a recommended maximum UV intensity for safe outdoor activity, a set of air pressure ranges corresponding to different altitudes (so that a climber, for example, may be alerted to any sudden changes in air pressure), and a recommended maximum magnetic field intensity for personal safety. The control unit 120 is configured for receiving the current environmental parameters, and comparing the current environmental parameters with the safe environmental parameters to generate a warning signal if any of the current environmental parameters is outside a range of the corresponding current environmental parameter. It is understood that the image processing chip 116 may be integrated into the control unit 120.

The warning unit 160 may be configured for activating a warning indicator in response to the warning signal to warn people who may be in a dangerous environment. The warning indicator may be an audio warning, such as beeps emitted by a speaker of the multifunction camera 100, and/or a visual warning message shown in the display of the display unit 140.

The input unit 170 may include a plurality of keys on the multifunction camera 100. People can select which type or types of the current environmental parameters, such as UV intensity, air pressure and/or magnetic field intensity are to be detected via the input unit 170.

Operation of the multifunction camera 100 is described below.

When the multifunction camera 100 is used outdoors, a user selects which current environmental parameters they want to know about via the input unit 170. Correspondingly, the UV sensor 152, the air pressure sensor 154, and the magnetic field sensor 156 of the sensing unit 150 detect the immediate environment to obtain current environmental parameters including current UV intensity, current air pressure, and current magnetic field intensity. The control unit 120 receives the current environmental parameters and compares the current environmental parameters with the predetermined safe environmental parameters stored in the storing unit 130. The current environmental parameters are also displayed in the display of the display unit 140. If any of the current environmental parameters, e.g. the current UV intensity, is outside a range of the corresponding predetermined safe environmental parameters, e.g. the recommended maximum UV intensity, the control unit 120 generates a warning signal, which is sent to the warning unit 160. The warning unit 160 sends an audio warning to warn people to take steps to protect their skin from being sunburned.

It is to be understood that the current environmental parameters can also be written as part of each image taken by the multifunction camera. When the image is shown or printed, the current environmental parameters can be shown or printed with the image so that people can obtain information about the immediate environment.

In summary, the multifunction camera 100 of the present embodiment not only warns people if they are in a dangerous environment, but also records the immediate environmental information while capturing images.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multifunction camera comprising:
an image capturing unit configured for capturing images;
a sensing unit for obtaining current environmental parameters of an immediate environment the multifunction camera is used in;
a storing unit configured for storing the images, the current environmental parameters, and predetermined safe environmental parameters;
a control unit configured for receiving the current environmental parameters, comparing the current environmental parameters with the safe environmental parameters, and generating a warning signal if any of the current environmental parameters is outside of a range of the corresponding predetermined safe environmental parameter; and
a warning unit configured for activating a warning indicator in response to the warning signal.

2. The multifunction camera of claim 1, wherein the image capturing unit includes a lens, an image sensor for converting light from the lens into electrical signals, and an image processing chip for processing the electrical signals to form the images.

3. The multifunction camera of claim 1, further comprising a display unit configured for showing the images and the current environmental parameters.

4. The multifunction camera of claim 3, further comprising an input unit configured for providing input functionality for people.

5. The multifunction camera of claim 1, wherein the sensing unit includes an ultraviolet sensor for detecting a current ultraviolet intensity of the immediate environment, an air pressure sensor for detecting a current air pressure of the immediate environment, and a magnetic field sensor for detecting a current magnetic field intensity of the immediate environment.

6. The multifunction camera of claim 5, wherein the current environmental parameters include the current ultraviolet intensity of the immediate environment, the current air pressure of the immediate environment, and the current magnetic-field intensity of the immediate environment; and the safe environmental parameters include a recommended maximum ultraviolet intensity for safe outdoor activity, a set of air pressures corresponding to different altitudes, and a recommended maximum magnetic-field intensity for personal safety.

7. The multifunction camera of claim 1, wherein the warning indicator includes at least one of an audio warning and a visual warning.
